(19) United States
(12) Patent Application Publication
(10) Pub. No.: US 2014/0164510 A1
(43) Pub. Date: Jun. 12, 2014

(54) RESCHEDULING UNFINISHED MEETING AGENDA TOPICS

(71) Applicant: INTERNATIONAL BUSINESS MACHINES CORPORATION, Armonk, NY (US)

(72) Inventors: Kelly Abuelsaad, Poughkeepsie, NY (US); Kulvir S. Bhogal, Fort Worth, TX (US); Lisa Seacat DeLuca, San Francisco, CA (US); Soobaek Jang, Hamden, CT (US)

(73) Assignee: INTERNATIONAL BUSINESS MACHINES CORPORATION, Armonk, NY (US)

(21) Appl. No.: 13/710,808

(22) Filed: Dec. 11, 2012

(51) Int. Cl. H04L 29/06

(52) U.S. Cl. CPC H04L 65/403
USPC 709/204

(57) ABSTRACT

Rescheduling unfinished meeting agenda topics includes detecting an unfinished meeting agenda topic at a conclusion of a meeting and rescheduling with a meeting management engine the unfinished meeting agenda topic to be addressed in a later meeting.

### BACKGROUND

The present invention relates to meeting management, and more specifically, to automatically rescheduling unfinished meeting agenda topics for a later meeting.

Programs help meeting participants manually schedule meetings and coordinate meeting details among themselves. Such programs allow a meeting moderator to view scheduled events of the desired meeting participants, manually select a time to schedule the meeting, and send an invitation to the meeting participants. The meeting moderator has an option to include a message in the meeting invitation, which may include a meeting place, a call in number, information related to the meeting, or other information desired to be included by the meeting moderator. The desired meeting participants have an option to accept the invitation, decline the invitation, or to suggest an alternative time to meet. The program tracks the meeting participants' responses. If desired, the meeting moderator can reschedule the meeting for a time more convenient for the desired meeting participants based on their responses.

### BRIEF SUMMARY

A method for rescheduling unfinished meeting agenda topics includes detecting an unfinished meeting agenda topic at a conclusion of a meeting and rescheduling with a meeting management engine the unfinished meeting agenda topic to be addressed in a later meeting.

A system for rescheduling unfinished meeting agenda topics includes an agenda topic engine to track progress of meeting agenda topics and determine at a conclusion of a meeting whether an unfinished meeting agenda topic exists and a meeting management engine to reschedule the unfinished meeting agenda topic for a later meeting.

A computer program product for rescheduling unfinished meeting agenda topics includes a tangible computer readable storage medium. The tangible computer readable storage medium has computer readable program code embodied therewith. The computer readable program code has program instructions that, when executed, cause a processor to track progress of meeting agenda topics, determine at a conclusion of a meeting whether an unfinished meeting agenda topic exists, and reschedule the unfinished meeting agenda topic for a later meeting.

### BRIEF DESCRIPTION OF THE SEVERAL VIEWS OF THE DRAWINGS

FIG. 1 is a diagram of an example of a meeting management engine according to one example of the principles described herein.

FIG. 2 is a diagram of an example of scheduling a later meeting according to one example of the principles described herein.

FIG. 3 is a diagram of an example of a method for rescheduling unfinished meeting agenda topics according to one example of the principles described herein.

FIG. 4 is a diagram of an example of a meeting system according to one example of the principles described herein.

FIG. 5 is a diagram of an example of a meeting system according to one example of the principles described herein.

FIG. 6 is a diagram of an example of a flowchart of a process for detecting an unfinished meeting agenda topic according to one example of the principles described herein.

FIG. 7 is a diagram is an example of a flowchart of a process for rescheduling unfinished meeting agenda topics according to one example of the principles described herein.

### DETAILED DESCRIPTION

The present specification describes a method and system for rescheduling unfinished meeting agenda topics such that the meeting management engine automatically tracks and reschedules a meeting for unfinished meeting agenda topics.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

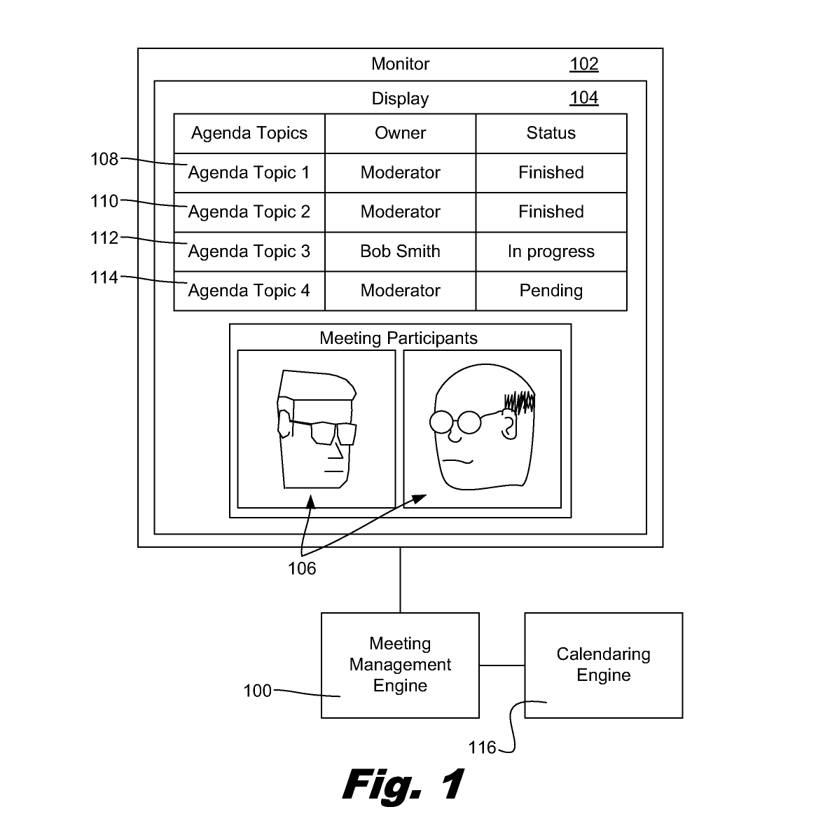

Referring now to the figures, FIG. 1 is a diagram of an example of a meeting management engine (100). In this example, the meeting management engine (100) is in communication with a monitor (102) with a display (104) showing agenda topics, the owner of the agenda topics, and the topics' status. The display (104) also shows images (106) of the meeting participants. Such an example may be used for a video conference. However, in other examples, the display (104) is used in face to face meetings, phone conferences, other meeting mechanisms, or combinations thereof.

The meeting moderator, who sets up the meeting, may be one of the meeting participants. The meeting moderator and/or meeting participants can be owners of each of the agenda topics. As the meeting proceeds, the meeting management engine (100) automatically tracks which of the agenda topics are discussed and causes the display (104) to show the status of each topic agenda in real time. In the example of FIG. 1, a first agenda topic (108) and a second agenda topic (110) are depicted as being finished. The third agenda topic (112) is in progress, and the fourth agenda topic (114) is pending, so the meeting participants have not yet addressed this agenda topic.

The meeting management engine (100) can track the agenda topics in a variety of different ways. For example, the meeting management engine (100) may track the topics by obtaining computer inputs or other types of inputs from the meeting participants when an agenda topic is completed. The meeting management engine (100) may request input from the meeting participants, or the meeting participants may initiate providing the input to the meeting management engine (100). In other examples, the meeting management engine (100) tracks the topics through auditory recognition. In such an example, a microphone provides the meeting management engine (100) auditory inputs recorded in real time as the meeting participants discuss agenda topics. The auditory inputs allow the meeting management engine (100) to recognize predetermined words from the meeting participants about the topics. For example, if the agenda topic is selecting a candidate for a job position, a non-exhaustive list of predetermined words may include “hire,” “candidate,” “interview,” “start date,” other words related to hiring, or combinations thereof. In this manner, the meeting management engine (100) may recognize when topics are discussed regardless of the order that the agenda topics come up during the meeting. Such auditory inputs may be picked up with a phone, microphone, lip reading programs, other auditory devices, or combinations thereof.

The meeting management engine (100) may also recognize which of the meeting participants is involved in the meeting. For example, if the meeting is part of a video conference, the meeting management engine (100) can recognize which of the meeting participants is on the line by recognizing phone numbers, through voice recognition, through an auditory device that detects meeting participants calling each other by name, through an introduction given by the meeting participants as they virtually enter the meeting, video image recognition, other mechanisms, or combinations thereof.

In some examples, the meeting management engine (100) recognizes when an owner of an agenda topic is absent from the meeting. In such examples, the meeting management engine (100) may determine that the absent owner's agenda topics were not finished during the meeting. The mere absence of an agenda topic owner may be enough for the meeting management engine (100) to determine that the owner's agenda topics are unfinished. However, in other examples, the absence of an owner is one of multiple factors for determining whether the agenda topic is unfinished.

The meeting management engine (100) determines that a meeting is concluded based on a conclusion policy. The conclusion policy may include determining that a meeting is concluded in response to a phone, microphone, or other auditory device ceasing to pick up a conversation among meeting participants. In other examples, the meeting management engine (100) determines that a meeting is concluded in response to all of the meeting participants exiting or logging out of a meeting system. Further, the meeting management engine (100) may use other mechanisms to determine when a meeting is concluded.

At the conclusion of the meeting, the meeting management engine (100) determines which of the agenda topics in unfinished. An unfinished meeting agenda topic may include topics that have been started, but not finished; topics that have not yet been addressed; and/or topics that need additional discussion. The meeting management engine (100) makes this determination based on an unfinished topic policy. This policy includes at least one factor. The factors may include whether the agenda topic owner was present in the meeting, whether an auditory sensor ever sensed the meeting participants using predetermined words, a computer input or other type of input that indicates an agenda topic was unfinished, a lack of a computer or other type of input that indicates an agenda topic was finished, other factors, or combinations thereof. An agenda topic may be unfinished because the scheduled time for the meeting ran out before the agenda topic could be finished, a meeting participant that needed to be involved in the topic's discussion was not present, the agenda topic needed more discussion than time allowed, other reasons, or combinations thereof.

While the example of FIG. 1 has been described with reference to a display (104) and monitor (106) in communication with the meeting management engine (100), other examples include no display or monitor. Such examples continue to have a meeting management engine (100) or other engines that track the progress of the meeting or has a mechanism where the meeting participants provide input about which agenda topics are finished and unfinished at the conclusion of the meeting. Such inputs may be computer inputs, verbal inputs, computer recognized gesture inputs, touch inputs, keyboard inputs, other inputs, or combinations thereof.

In other examples, the meeting management engine (100) has a display, but with less features than depicted in the example of FIG. 1. For example, the display may omit the images of the meeting participants, the agenda topic statuses, agenda topic owners, the list of agenda topics, or combinations thereof. In yet other examples, the display may include additional features not included in the example of FIG. 1. For example, the display (104) may include time allocations for each agenda topic, start time of the meeting, projected end time for the meeting to conclude, meeting presentations, video presentations, other presentations, meeting documents, other features, or combinations thereof.

If an agenda topic is determined to be unfinished at the conclusion of the meeting, the meeting management engine (100) reschedules the unfinished meeting agenda topics for a later meeting. In the example of FIG. 1, the third agenda topic (112) is classified as unfinished because it was still in progress at the conclusion of the meeting. Thus, the topic is likely to need additional discussion. Also, the fourth agenda topic (114) is also classified as unfinished because this agenda topic was not started or unaddressed during the meeting. The later meeting may be a meeting that was previously scheduled, but will take place after the original meeting. The previously scheduled meeting may include the next meeting in a series of repeating meeting, a related meeting, a follow-up meeting, subsequent meeting that is not the next meeting in a series of repeating meetings, another meeting, or combinations thereof. A later meeting may already have some of the meeting participants desired to be present for unfinished agenda topics scheduled to attend, and the meeting management engine (100) schedules the unfinished agenda topics for that meeting. In such an example, the meeting management engine (100) may cause an update to be sent to the meeting participants already invited to the later meeting and send an invitation to those meeting participants who were not originally invited to the later meeting.

A previously scheduled meeting with all of the same meeting participants is a good candidate to reschedule the unfinished meeting agenda topics. The meeting management engine (100) may detect how much time is needed for the unfinished agenda topics and estimate the amount of time needed for the later meeting. If the previously scheduled meeting does not have sufficient time to cover the additional topics added by the meeting management engine (100), the meeting management engine (100) extends, or gives the option to extend, the time allocated in the previously scheduled meeting such that there is sufficient time for the additional agenda topics. Likely candidates for previously scheduled meetings include regularly scheduled meetings, such as meetings on a weekly or bi-weekly basis. If such regularly scheduled meetings are scheduled farther apart, then the meeting management engine may send a recommendation to the meeting moderator asking if scheduling a meeting out that far in advance is acceptable or if the unfinished meeting agenda topics should be addressed earlier. In other examples, the meeting management engine (100) uses a predetermined time threshold to determine whether a previously scheduled meeting is too far out for rescheduling the unfinished agenda topics.

In other examples, the meeting management engine (100) creates a new meeting to reschedule the unfinished meeting agenda topics. The meeting management engine (100) may create a new meeting regardless of whether an acceptable previously scheduled meeting exists. In other examples, the creation of a new meeting is used just when an appropriate previously scheduled meeting cannot be found.

The meeting management engine (100) may determine to establish a new meeting or schedule the unfinished agenda topics to a previously scheduled meeting by consulting with a calendaring engine (116). The calendaring engine (116) contains the schedules of the meeting participants and has an ability to set up meetings for the desired meeting participants.

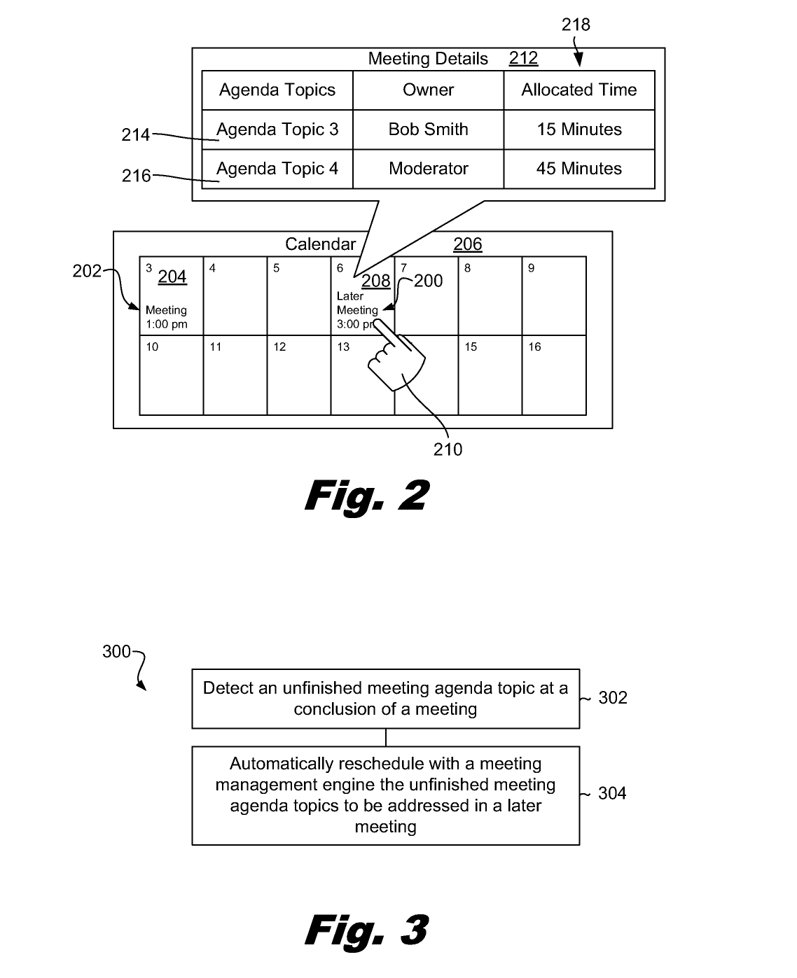

FIG. 2 is a diagram of an example of scheduling a later meeting (200). In this example, the original meeting (202) was scheduled on a 3^{rd} day (204) of a month in a calendar (206) maintained with the calendaring engine, (116, FIG. 1). The later meeting (200) scheduled on the 6^{th} day (208) of the month may be either a newly created meeting by the meeting management engine (100, FIG. 1) to address the unfinished agenda topics from the original meeting (202) or a previously scheduled meeting. If the later meeting (200) is a previously scheduled meeting, the meeting management engine checks to ensure that there is sufficient time in the later meeting (200) to cover additional topics.

In the example of FIG. 2, an icon (210) is hovered over the later meeting (200). In response to the hovering, a box (212) depicting the details of the later meeting (200) reveals that the third agenda topic (214) and the fourth agenda topic (216) are scheduled in the later meeting. Further, a time allocation column (218) is included in the box (212). Allocating time to each of the agenda topics ensures that the meeting management engine can schedule a newly created meeting or extend a previously scheduled meeting to have sufficient time for the agenda topics.

FIG. 3 is a diagram of an example of a method (300) for rescheduling unfinished meeting agenda topics. In this example, the method (300) includes detecting (302) an unfinished meeting agenda topic at a conclusion of a meeting, and automatically rescheduling (304) the unfinished meeting agenda topics to be addressed in a later meeting with a meeting management engine.

The meeting management engine may track the progress of agenda topics during the duration of the meeting. In other examples, the meeting management engine obtains input at the conclusion of the meeting regarding which topics are unfinished. The input may be manually provided by the meeting participants.

Unfinished meeting agenda topics are determined based on an unfinished topic policy. Such a policy may include factors, such as recognizing whether the owner of an agenda topic is absent from the meeting. Ownership status of an agenda topic may be assigned by the moderator to meeting participants who have expertise or responsibility relating to the topic's subject matter. In cases where multiple meeting participants are needed for an agenda topic because of their expertise or responsibility, more than one meeting participant can be classified as an agenda topic owner. In other examples, the agenda topic's owner is a meeting participant who provided the topic to the meeting management engine, such as through key board, touch, or other computer inputs. Another policy factor may include whether the topic was in progress when the meeting concluded or whether the topic was never addressed during the meeting. In some examples, if any of these factors is present, the policy has a rule to conclude that the topic is unfinished. In other examples, the policy considers multiple factors with some of the factors having a greater weight than other factors. In other examples, the meeting participants provide input to the meeting management engine about which topics are finished and which topics are unfinished.

In some examples, the user has an option to adjust the sensitivity of the unfinished agenda topic determination. For example, the user may adjust the settings of the meeting management engine such that just agenda topics expressly inputted into the engine at the conclusion of the meeting are classified as unfinished. In other examples, the user can adjust the settings such that any agenda topic with specific predetermined words repeated less than a predetermined number of times during the meeting are classified as unfinished. The user may have the option to correlate the sensitivity based on the importance of the agenda topics. For those agenda topics of less importance, the meeting management engine may use a lower sensitivity and risk missing an unfinished agenda topic. On the other hand, for those agenda topics of high importance, the meeting management engine can have the sensitivity high enough to err on the side of caution. Each of the agenda topics may be assigned the same sensitivity, a default sensitivity, a customized sensitivity, an adjustable sensitivity, another sensitivity, or combinations thereof.

The later meeting may be created in response to the detection of an unfinished meeting agenda topic. In other examples, the later meeting is a previously scheduled meeting that is to take place subsequent to the original meeting. The meeting management engine may determine whether the previously scheduled meeting has enough time for the additional agenda topics. If not, the meeting management engine may extend the previously scheduled meeting to have enough time.

The meeting management engine consults with a calendaring engine to determine meeting participant's availability. If a new meeting is created, the meeting management engine causes an invitation to be sent to each of the meeting participants. In other examples, if the later meeting is a previously scheduled meeting, the meeting management engine causes a meeting update to be sent to each of the meeting participants notifying them about the changes to the meeting, such as the additional topic and any meeting time extensions.

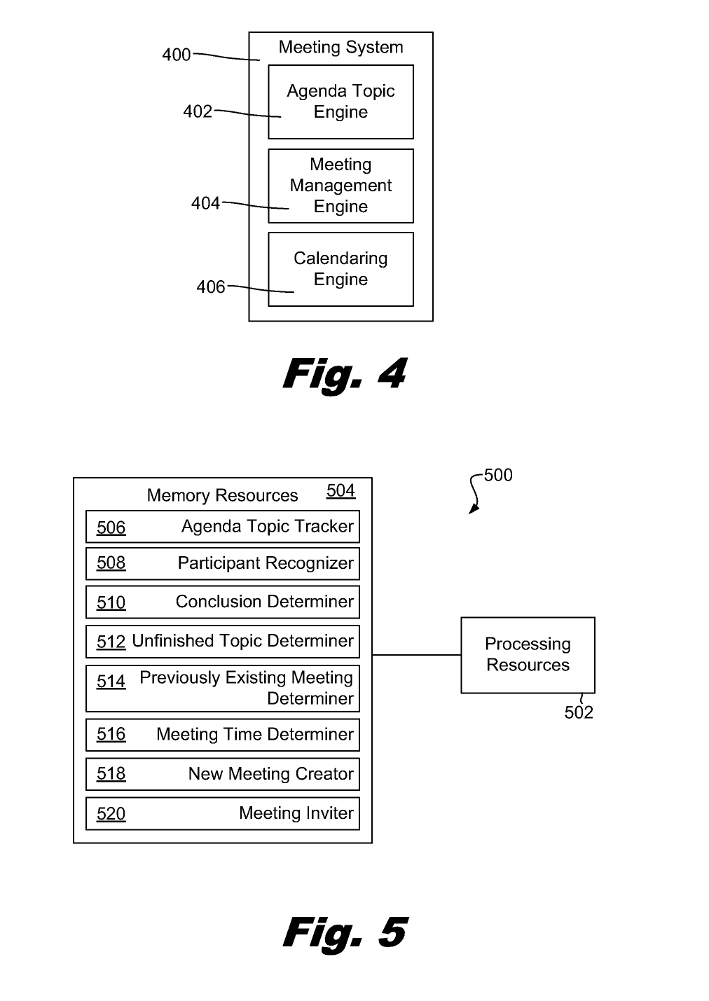

FIG. 4 is a diagram of an example of a meeting system (400). In this example, the meeting system (400) has an agenda topic engine (402), a meeting management engine (404), and a calendaring engine (406). The engines (402, 404, 406) refer to a combination of hardware and program instructions to perform a designated function. Each of the engines (402, 404, 406) may include a processor and memory. The program instructions are stored in the memory and cause the processor to execute the designated function of the engine.

The agenda topic engine (402) determines the topics that are to be included in the meeting and determines which of the topics is unfinished at the conclusion of the meeting. The meeting management engine (404) schedules the unfinished meeting agenda topics in a later meeting in response to detecting that the at least one of the meeting agenda topics is unfinished. The meeting management engine (404) may consult with a calendaring engine (406) to determine the availability of the meeting participants. In some examples, the meeting management engine (404) causes the calendaring engine (406) to send invitations or updates to the meeting participants to reflect either changes to previously scheduled meetings or the creation of a new meeting.

FIG. 5 is a diagram of an example of a meeting system (500). In this example, the meeting system (500) includes processing resources (502) that are in communication with memory resources (504). Processing resources (502) include at least one processor and other resources used to process programmed instructions. The memory resources (504) represent generally any memory capable of storing data such as programmed instructions or data structures used by the meeting system (500). The programmed instructions shown stored in the memory resources (504) includes an agenda topics tracker (506), participant recognizer (508), conclusion determiner (510), unfinished topic determiner (512), previously existing meeting determiner (514), meeting time determiner (516), new meeting creator (518), and meeting inviter (520).

The memory resources (504) include a computer readable storage medium that contains computer readable program code to cause tasks to be executed by the processing resources (502). A non-exhaustive list of computer readable storage medium types includes non-volatile memory, volatile memory, random access memory, memristor based memory, write only memory, flash memory, electrically erasable program read only memory, or types of memory, or combinations thereof.

The agenda topic tracker (506) represents programmed instructions that, when executed, cause the processing resources (502) to track the progress of the agenda topics through a meeting. The agenda topic tracker (506) may track the progress through obtaining manual inputs from the meeting participants, auditory recognition of words spoken in the meeting, the attendance of agenda topic owners in the meeting, other mechanisms, or combinations thereof. The participant recognizer (508) represents programmed instructions that, when executed, cause the processing resources (502) to recognize the attendance of meeting participants, and therefore, whether an agenda topic owner is present to determine whether his or her agenda topic will be covered during the meeting.

The conclusion determiner (510) represents programmed instructions that, when executed, cause the processing resources (502) to determine that the meeting is concluded. The unfinished topic determiner (512) represents programmed instructions that, when executed, cause the processing resources (502) to determine which topics, if any, are unfinished at the conclusion of the meeting.

The previously existing meeting determiner (514) represents programmed instructions that, when executed, cause the processing resources (502) to determine whether a previously scheduled meeting that is to take place after the original meeting is suitable for scheduling the unfinished agenda topics. If no such previously scheduled meeting is available, then a meeting time determiner (516) may be used. The meeting time determiner (516) represents programmed instructions that, when executed, cause the processing resources (502) to determine a time that the meeting participants are available for another meeting to discuss the unfinished agenda topics. The new meeting creator (518) represents programmed instructions that, when executed, cause the processing resources (502) to create a new meeting in the time that the meeting participants are available. The meeting inviter (520) represents programmed instructions that, when executed, cause the processing resources (502) to invite the meeting participants to the newly created meeting to discuss the unfinished meeting agenda topics.

Further, the memory resources (504) may be part of an installation package. In response to installing the installation package, the programmed instructions of the memory resources (504) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (502) and the memory resources (504) are located within the same physical component, such as a server, or a network component. The memory resources (504) may be part of the physical component's main memory, caches, registers, non-volatile memory, or elsewhere in the physical component's memory hierarchy. Alternatively, the memory resources (504) may be in communication with the processing resources (502) over a network. Further, the data structures, such as the libraries and may be accessed from a remote location over a network connection while the programmed instructions are located locally. Thus, the meeting system (500) may be implemented on a user device, on a server, on a collection of servers, or combinations thereof.

The meeting system (500) of FIG. 5 may be part of a general purpose computer. However, in alternative examples, the meeting system (500) is part of an application specific integrated circuit.

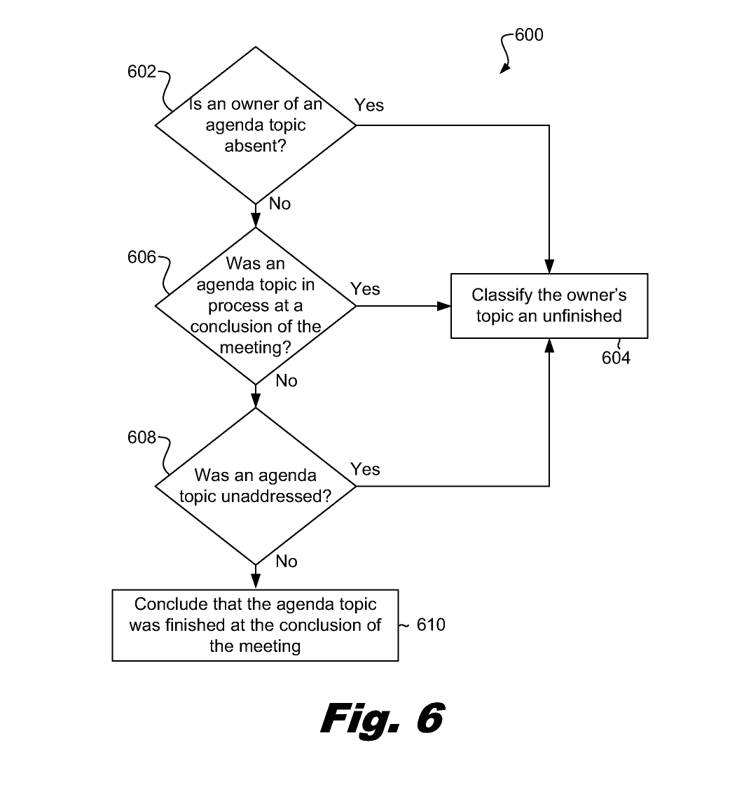

FIG. 6 is a diagram of an example of a flowchart (600) of a process for detecting an unfinished meeting agenda topic. In this example, the process includes determining (602) whether an owner of an agenda topic is absent. If so, then the agenda topic is classified (604) as unfinished for purposes of rescheduling the agenda topic for a later meeting. If the owner is present, then the process includes determining (606) whether the agenda topic is in progress at a conclusion of the meeting. If so, then the process includes classifying (604) that agenda topic as unfinished. If the agenda topic was not in progress at the conclusion of the meeting, then the process determines (608) whether the agenda topic was addressed at all in the meeting. If not, the agenda topic is classified (604) as unfinished. On the other hand, if the agenda topic was addressed during the meeting, the process concludes (610) that the agenda topic was finished at the meeting's conclusion.

The process of determining whether an agenda topic is unfinished at the conclusion of the meeting may be run on each agenda topic separately. Thus, at the conclusion of a meeting, some of the agenda topics can be classified as unfinished while other agenda topics are concluded to be finished.

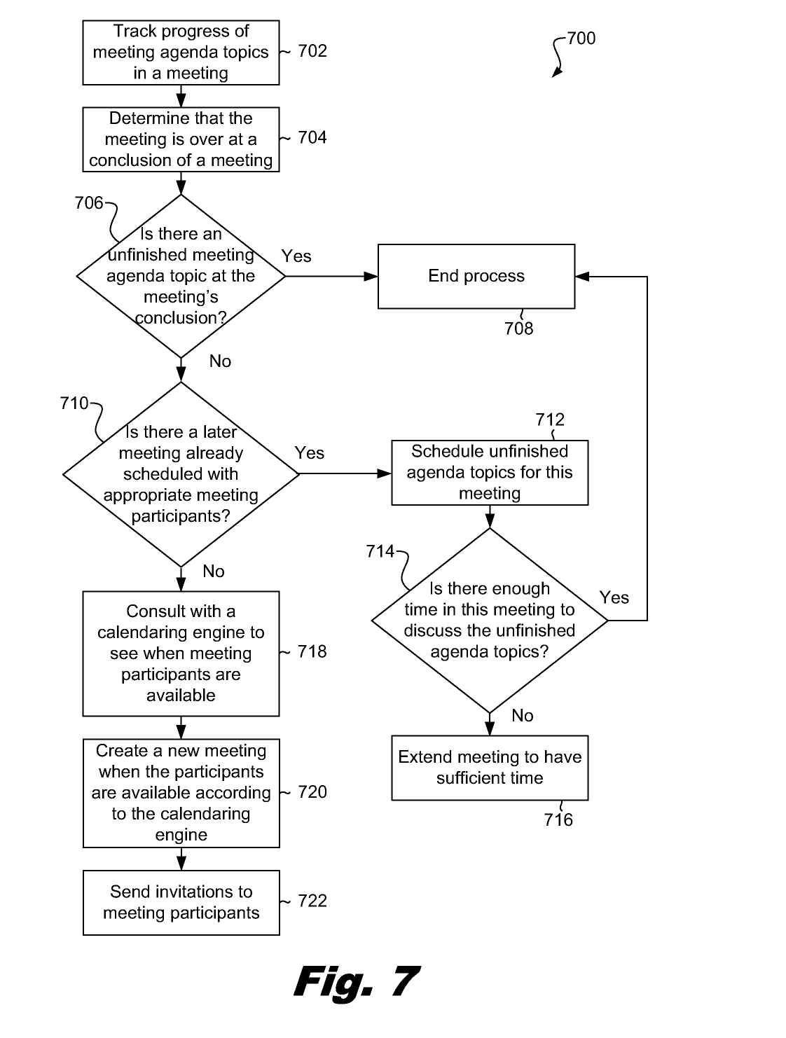

FIG. 7 is a diagram is an example of a flowchart (700) of a process for rescheduling unfinished meeting agenda topics. In this example, the process includes tracking (702) progress of meeting agenda topics in a meeting and determining (704) that the meeting is over at a conclusion of the meeting. If no unfinished meeting agenda topics are determined (706) to exist at the meeting's conclusion, the process ends (708).

However, if an unfinished meeting agenda topic is determined (706) to exist at the conclusion of the meeting, the process includes determining (710) whether a later meeting is already scheduled with the appropriate meeting participants to discuss the unfinished agenda topics. If a previously scheduled meeting is available, then the unfinished agenda topics are scheduled (712) for this meeting. Next, the process includes determining (714) if the previously scheduled meeting has enough time to discuss the additional topics. If there is sufficient time, then the process ends (708). However, if there is not enough time, the previously scheduled meeting is extended (716) to ensure sufficient time to discuss the additional topics.

If there is no previously scheduled meeting available that is appropriate to reschedule the unfinished agenda topics, the process includes consulting (718) with a calendaring engine to see when the meeting participants are available for another meeting. Next, a new meeting is created (720) when the meeting participants are available according to the calendaring engine and sending (722) invitations to the meeting participants.

While the examples above have been described with reference to specific displays and tracking mechanisms, any appropriate type of display or tracking mechanism may be used in accordance with the principles described herein. Further, while the examples above have been described with reference to specific conclusion policies and unfinished agenda policies, any appropriate factors relevant to determining the conclusion of a meeting and whether an agenda topic is finished at the conclusion of the meeting may be used in accordance with the principles described herein. Also, while the examples above have been described with reference to specific features in a meeting management engine and a calendaring engine, any appropriate features in these engines that are compatible with the principles described herein may be used.

The descriptions of the various examples of the present invention have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method for rescheduling unfinished meeting agenda topics, comprising:
detecting an unfinished meeting agenda topic at a conclusion of a meeting; and
automatically rescheduling with a meeting management engine an unfinished meeting agenda topic to be addressed in a later meeting.

2. The method of claim 1, wherein said later meeting is created in response to detecting said unfinished meeting agenda topic.

3. The method of claim 1, wherein automatically rescheduling with said meeting management engine includes determining a meeting duration for said later meeting that is sufficient for addressing said unfinished meeting agenda topic.

4. The method of claim 1, wherein said later meeting is a previously scheduled meeting to take place subsequent to said meeting.

5. The method of claim 4, further comprising determining whether said previously scheduled meeting has sufficient time to address said unfinished meeting agenda topic.

6. The method of claim 4, further comprising extending a duration of said previously scheduled meeting to give sufficient time for said unfinished meeting agenda topic.

7. The method of claim 1, wherein detecting said unfinished meeting agenda topic at said conclusion of said meeting includes determining an owner of said unfinished meeting agenda topic is absent from said meeting.

8. The method of claim 1, wherein detecting said unfinished meeting agenda topic at said conclusion of said meeting includes determining that a started meeting agenda topic was unfinished before said conclusion of said meeting.

9. The method of claim 1, wherein detecting said unfinished meeting agenda topic at said conclusion of said meeting includes determining that at least one of a plurality of agenda topics was unaddressed during said meeting.

10. The method of claim 1, further comprising tracking process of meeting agenda topics during said meeting.

11. The method of claim 1, wherein automatically rescheduling with said meeting management engine includes referencing a calendaring engine that tracks schedules of meeting participants and said rescheduling said unfinished meeting agenda topics when said meeting participants are available according to said calendaring engine.

12. The method of claim 1, wherein automatically rescheduling with said meeting management engine includes sending invitations to meeting participants through said meeting management engine.

13. A system for rescheduling unfinished meeting agenda topics, comprising:
an agenda topic engine to track progress of meeting agenda topics and determine at a conclusion of a meeting whether an unfinished meeting agenda topic exists; and
a meeting management engine to automatically reschedule said unfinished meeting agenda topic for a later meeting.

14. The system of claim 13, wherein said meeting management engine consults with a calendaring engine to reschedule said later meeting.

15. The system of claim 13, wherein said later meeting is a new meeting created in response to determining an existence of said unfinished meeting agenda topic or a previously scheduled meeting to take place subsequent to said meeting.

16. The system of claim 15, wherein said meeting management engine determines whether said previously scheduled meeting has sufficient time to address said unfinished meeting agenda topic.

17. The system of claim 15, further comprising extending a duration of said previously scheduled meeting to give sufficient time for said unfinished meeting agenda topic.

18. A computer program product for rescheduling unfinished meeting agenda topics, comprising:
a tangible computer readable storage medium, said tangible computer readable storage medium comprising computer readable program code embodied therewith, said computer readable program code comprising program instructions that, when executed, causes a processor to:
track progress of meeting agenda topics;
determine at a conclusion of a meeting whether an unfinished meeting agenda topic exists; and
reschedule said unfinished meeting agenda topic for a later meeting.

19. The computer program product of claim 18, further comprising computer readable program code to, when executed, cause said processor to determine a meeting duration for said later meeting that is sufficient for addressing said unfinished meeting agenda topic.

20. The computer program product of claim 18, further comprising computer readable program code to, when executed, cause said processor to determine whether an owner of said unfinished meeting agenda topic is absent from said meeting.
